(19) United States
(12) Patent Application Publication
(10) Pub. No.: US 2006/0152349 A1
(43) Pub. Date: Jul. 13, 2006

(54) Smart Parking Meter

(76) Inventor: Nitesh Ratnakar, Oak Creek, WI (US)

Correspondence Address: NITESH RATNAKAR, 8600 S. LIBERTY LN #2410, OAK CREEK, WI, 53154, US

(21) Appl. No.: 10/905,467

(22) Filed: Jan. 5, 2005

(51) Int. Cl. B60R 25/10

(52) U.S. Cl. 340/426.1

(57) ABSTRACT

The present invention relates to a ‘smart parking system’ comprising of 1) ‘smart parking meter’ containing a radiofrequency reader (RF reader); 2) radiofrequency tag (RF tag) containing vehicle identification information, that is mounted on vehicles; 3) a central control station communicating with a multitude of ‘smart parking meters’ to form a network; 4) the said central control station having a central computer system programmed with parking enforcement instructions. RF reader is provided with means to interrogate the RF tag of a vehicle parked in the corresponding parking stall; and transmit information obtained thereby to a central control station. The central control station has means to identify the said vehicle and determine whether or not the said vehicle is legally parked. If a parking violation is detected, the central computer system remotely instructs the corresponding ‘smart parking meter’ to issue a parking ticket. Means are also provided in the ‘smart parking system’ to determine if a vehicle parked in a parking stall has previous unpaid parking tickets. The ‘smart parking system’ also has means to determine if a vehicle wanted by law enforcement personnel is present in a parking stall within its network. According to yet another aspect, the ‘smart parking system’ has means to determine if a parking stall in its network is vacant and to reserve the said vacant stall for an authorized driver. Further, means are provided in the ‘smart parking meter’ to accept multiple forms of payment.

### FIELD OF INVENTION

The present invention relates to parking meters, more specifically to a parking meter that is able to determine the identity of a vehicle parked in the corresponding parking stall. According to another aspect, the present invention relates to parking meters that have means to communicate with remote parties.

### BACKGROUND AND PRIOR ART

Municipal governments enact regulations to govern the parking of cars along city streets. Typically, time limits are posted along each street and parking fines are levied on vehicle owners who park their cars for longer than the posted time. Three benefits result from the practice of making and enforcing on-street parking regulations: 1) Traffic congestion is reduced by forcing drivers parked in the on-street parking stalls for long periods to find suitable off-street parking arrangements, thereby vacating the more convenient, on-street parking stalls for use by drivers wishing to stop for short periods; 2) The parking fines levied on drivers who violate parking regulations create revenue for the municipality; 3) Rental from the parking stalls bring in recurring revenue to the municipality. In order to reap these benefits, the fundamental technical problem faced by parking authorities is how to detect when vehicles are in violation for the posted time limit. It is difficult for parking authorities to monitor parking stalls for violation at all times.

Presently parking meters are employed to collect revenue from eligible parking stalls. Parking meters are timing devices installed adjacent to parking stalls. Once installed, parking meters permit drivers to rent each parking stall for short periods, typically for a maximum period of 2 hours. To rent the stall, the motorist must insert coins into the meter, thereby starting a timer mechanism that suppresses display of an “Illegally Parked” flag. When the purchased parking period has expired, the “Illegally Parked” flag is again made plainly visible, thereby enabling a parking enforcement officer patrolling the area to see at a glance that the parking stall is illegally occupied. The officer inspects every parking meter along the patrol route at regular intervals and issues parking tickets to those cars that are illegally parked. Detecting parking violations with parking meters is an effective means of enforcing regulations, particularly in areas with high traffic density such as downtown commercial districts. A significant advantage of using parking meters to detect violations is that they also provide a means for collecting a “pay per use” parking fee. The requirement to insert coins provides a continual stream of revenue to the municipality, even if no vehicle is ever cited for an over-parking violation. However, the conventional parking meters have many shortcomings.

Currently a city police officer or a parking ticket officer or an attendant is required to walk along the street to inspect each parking meter to see if there is parking violation. Since the enforcement officer must visually inspect each parking meter along the route, patrolling the meters is a tedious and labor intensive activity that adds significantly to the overall cost of metered enforcement. In congested, downtown areas, officers are often required to patrol the route on foot, thereby adding to the labor cost of the system. Moreover, it is not possible to patrol all parking stalls at all times. Parking stalls usually go unmonitored for most part during the time when drivers are required to pay parking fee. This leads to lost revenue that would have been generated in the form of rental from the parking stalls; and in fines from drivers who do not pay parking rental. Revenue is also lost when a second car parks at a meter while time remains on the meter from a previously parked vehicle. Another revenue loss occurs because it is difficult to change meter schedules to account for special events, such as during a baseball game. Once a parking violation is detected, creating a legal parking ticket and serving it on the vehicle's owner takes a considerable amount of time and effort. The main factor contributing to this workload is the requirement for the officer to write down all the details of the violation by hand onto a paper parking ticket; before affixing it to the offending vehicle (time, location, license plate number, nature of violation, etc). Furthermore, the labor cost of processing each parking ticket is increased by the requirement to transcribe the hand-written data into a computerized system that tracks the violation through the court system.

Contests by the drivers after a parking ticket has been issued, is another source of added costs. The concerned officer often has to report to the court at the time of hearing. Consequently, there are fewer officers patrolling the streets to enforce laws. This further strains an already strained law enforcement system of major cities. Malfunction of the parking meter is a common ground for contests by drivers. With the current parking meters, it is often difficult to prove whether or not a parking meter was working at the time a parking ticket was issued. Another factor that degrades the performance of the present enforcement system is their incapacity to detect “scofflaw” drivers. “Scofflaw” is the term commonly used by parking authorities for a driver who flouts parking regulations. Scofflaws flout parking regulations by discarding or otherwise ignoring all parking tickets they receive. The current parking enforcement system can not detect whether or not the vehicle's owner is likely to pay the fine levied for violation. Since many of the parking tickets written by officers are ignored by scofflaw drivers, the inability of the meter enforcement methodology to deal effectively with scofflaw drivers reduces their fiscal efficiency. Another factor that limits the fiscal efficiency of the present parking meters is that they are able to accept only coins of certain denominations as a form of payment. Drivers are sometimes unable to pay for parking because the accepted denomination of coins is not readily available. In addition, payment using coins can be cumbersome. For example, payment for a two hour rental at a cost of 25 cents/15 minutes, requires 8 quarters. Drivers usually do not carry coins in bulk quantity. Therefore, they end up parking their vehicles without paying the parking fee, although they did not have any intentions to do so.

Many prior art devices have been reported that have tried to modernize the conventional parking enforcement system. In U.S. Pat. No. 4,823,928; Speas has disclosed an electronic parking meter system for receiving at least one type of coin or other payment device and having an electronic parking meter and an auditor. The electronic parking meter comprises a power source which may be a solar type power source, as well as, having terminals for connection to an external source of power. The meter also has a microprocessor with a memory connected to the power supply. An electronic display is connected to the microprocessor and displays pertinent information for the meter. The auditor may be connected to the microprocessor in the electronic meter by means of a direct cable link or by infrared transmission. The electronic parking meter system may have a sonar range finder connected to the microprocessor in the meter which detects the presence or absence of a vehicle in an associated parking stall with the parking meter. In U.S. Pat. No. 4,861,971; Chan has disclosed a parking meter capable of being operated without the use of a monetary coin. The parking meter is intended to be used with an account card incorporating a read/write memory (e.g. a magnetic strip) pre-recorded with a monetary value. The parking meter has a body with a slot or the like for receiving the account card, means for reading the memory on the card, a comparator for comparing information from the memory with stored information, a timer for measuring a predetermined time period, an indicator for indicating the elapse of the time period, a start mechanism for the timer having an enabling or disabling control governed by the comparator and an amending device for amending the memory on the account card to deduct the value of the parking period bought by the user.

In U.S. Pat. No. 6,037,880 Manion has disclosed an integrated parking meter system that automates the issuance of parking citations. Each parking meter is equipped with a sonar range finder, mercury type switch and a two way radio that communicates via N-PCS to a host computer back at the control center. When a meter runs out of money, it checks to see if a vehicle is present in the parking space. If it is, the meter notifies the host computer that there is a car illegally parked in the space. The host computer correlates the information to identify the exact location of the violator. The host computer then sends this information via wireless network to the parking meter attendants' personal communicator. The parking attendant proceeds to the violator and issues the citation. Included within this technology is the capability to remotely change the rate structure of any or all electronic parking meters. A meter diagnostic feature alerts repair personnel to specific malfunctioning meters. The meter may also set the time remaining on the meter to zero whenever a car leaves the adjacent space.

While the prior art devices may be useful is some respects, they have shortcomings. 1) None of the prior art devices provide a reliable way to determine the identity of the parked vehicle. Hence, parking enforcement officials are still required to manually inspect parking stalls and issue parking tickets by hand; 2) None of the prior art devices enable tracing a wanted vehicle such as a vehicle that is stolen or involved in illegal activities; 3) The prior art devices do not enable drivers to pay parking tickets remotely; 4) The prior art devices do not enable detection and reservation of vacant parking stalls for drivers who need one.

### OBJECTS OF THE INVENTION

Accordingly, it is the general object of this invention to provide a parking meter that addresses the aforementioned needs. The present invention is designed to provide 1) a parking meter with means to reliably determine the identity of a parked vehicle 2) a parking system with means to automatically determine whether or not a vehicle is legally parked; 3) a parking meter with means to automatically issue a parking ticket when violation is detected; thereby obviating the need for parking enforcement officials to manually inspect the parking stalls and issue parking tickets by hand; 4) a parking system that enables locating a vehicle wanted by law enforcement officials; 5) a parking meter with means to accept multiple forms of payment including pre-paid card, credit or debit card, paper bills and coins; 6) a parking meter that enables drivers to pay and contest parking tickets remotely; 7) a parking system with means to detect and reserve vacant parking stalls; 8) a parking meter with means to transmit parking meter and vehicle related data to a central facility; 9) a parking meter that resets itself whenever a vehicle leaves before the allotted time passes; 10) a parking system with means to determine whether or not a vehicle has delinquent parking tickets; 11) a parking meter that enables a vehicle to remind its driver of parking tickets that have not been paid. In addition to addressing the shortcomings of the prior art devices, the smart parking meter provides innovative solutions to the problems encountered with the current parking enforcement system. It assists and improves driver compliance with parking regulations and provides multiple avenues to increase revenue for a municipality.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out one or several purposes of the present invention. It is important, therefore, that the claims be regarded as including such equivalent constructions insofar as they do not depart from the spirit and scope of the present invention.

### SUMMARY OF THE INVENTION

The present invention uses the radiofrequency identification (RFID) technology. A parking meter is provided that contains a radiofrequency reader (RF reader). A radiofrequency tag (RF tag), containing vehicle identification information, is mounted on vehicles. The RF reader of the parking meter has means to interrogate the RF tag of a vehicle parked in the corresponding parking stall. A modem and wireless transceiver is provided which enables the parking meter to communicate with a central control station and other remote parties. Vehicle identification information obtained upon interrogating the RF tag of a vehicle is transmitted to a central control station. The computer system at the central control station processes the vehicle information according to programmed instructions that takes into account parking regulations, fee schedule, parking restrictions, maximum allowable time and other relevant information. It has means to determine whether or not the said vehicle is legally parked. If a parking violation is detected, the central control station sends instructions to the said parking meter to issue a parking ticket.

### BRIEF DESCRIPTION OF THE DRAWINGS

FIG. 1 shows a composite picture of the parking meter assembly of the present invention comprising of the smart parking meter and a support stand.

FIG. 2 shows the front view of the smart parking meter.

FIG. 3 shows the interior view of the smart parking meter.

FIG. 4 shows a parking lot comprising of parking stalls equipped with smart parking meters. It also shows vehicles equipped with transponders containing vehicle identification data.

FIG. 5 shows the communication network of the radiofrequency transponder of the present invention.

FIG. 6 is an illustration of the internal circuitry of the smart parking meter.

FIG. 7 shows the data input in the central processing unit of the smart parking meter.

FIG. 8 shows the communication network of the parking enforcement system of the present invention.

FIGS. 9A & 9B show the two methods of data processing in the parking enforcement system of the present invention.

FIG. 10 is the algorithm of the functioning of the smart parking meter that enables general parking enforcement.

FIG. 11 is the algorithm of the functioning of the smart parking meter that enables parking enforcement in areas with zone parking restrictions.

FIG. 12 is the algorithm of the functioning of the smart parking meter that enables locating and reserving vacant parking stalls.

### DETAILED DESCRIPTION

The parking enforcement system of the present invention utilizes radiofrequency identification (RFID) technology. RFID technology is a radio communication system that communicates between a radio transceiver, called an ‘Interrogator’ or ‘Reader’, and a number of inexpensive devices denoted as ‘Tags’ or ‘Transponders’. RF tags provide a means of obtaining data without direct contact such as is needed with magnetic strip or bar code technology. Such tags have been around for some time. U.S. Pat. No. 3,713,148 issued to Cardullo et al. on Jan. 23, 1973, and incorporated herein by reference, describes a tag, which includes a changeable or writable memory. The tags are self-contained in hermetically sealed capsules or laminates requiring no external power since they get power by rectifying the energy in a field created by the interrogator and storing the energy in capacitive-type circuitry. Nevertheless, some tags may be powered with small batteries. RF tags come in a variety of embodiments from a thin, flat and flexible form-factor (thin type) to small capsules (cylindrical type). An example of a thin form-factor is described in U.S. Pat. No. 5,528,222 issued to Moskowitz et al in 1996. Although the term “radio frequency” is used, other parts of the electromagnetic spectrum may be used to create the energy field. UHF, microwave and millimeter wave sources may be used by the reader depending on the distance between the reader and the tag; and the material to be penetrated. In RF system, the reader communicates with the tags using modulated radio signals, which activate any tag in range; or a specific tag within the range. After activating a tag, the reader may transmit information to it (this is called the downlink). The reader transmits a continuous-wave (CW) radio signal to the tag; the tag then modulates the CW signal using modulated backscattering (MBS) in which the tag is electrically switched by the modulating signal, from being an absorber of RF radiation to a reflector of RF radiation. This modulated backscatter allows communications from the tag back to the reader (called the uplink). The downlink transmission of messages can include information relating to a desired operation of the RF tag and, for example, the reader is capable of instructing the RF tag to turn on and/or off on demand.

RF tags come in two varieties: active and passive. An active RF tag includes a battery or other power source, and is activated by a signal from a reading device. The activated RF tag then broadcasts its identification or other data, which is picked up by the reading device. An advantage of active RF tags over passive RF tags is that the inclusion of a power source allows the active RFID to transmit to a receiver without entering into an electromagnetic field to power the tag circuit. Active RF tags are also generally able to transmit over a longer distance. The advantages of active RF tags has led to its use in automatic toll-paying systems, or the like. However, an active RF tag has certain disadvantages compared to a passive RF tag. For example, because the active RF tag requires a battery or other power source, it is more expensive and heavier than a passive RF tag. Additionally, the active RF tag becomes useless when the battery or other power source is depleted. Passive RF tags have no power supply per se, but power is provided to the RF circuitry by using an electromagnetic power receiver. The RF reading device sends power to the RF tag's electromagnetic power receiver, thus powering up or turning on the RF tag's circuits. Next, the passive RF tag broadcasts a response signal containing identification or other information, which is then read by the reading device. Because the passive RF tag has no battery, it is less expensive and lighter. Passive RF tags have been in use for some time, notably in security access cards where the user holds the card near the card reader to unlock a door, and in clothing stores as security tags attached to clothing items. Either of these two technologies can be used with the parking meter of the present invention depending of the desired features and should not be considered limiting.

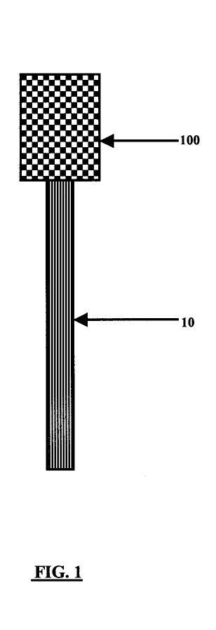

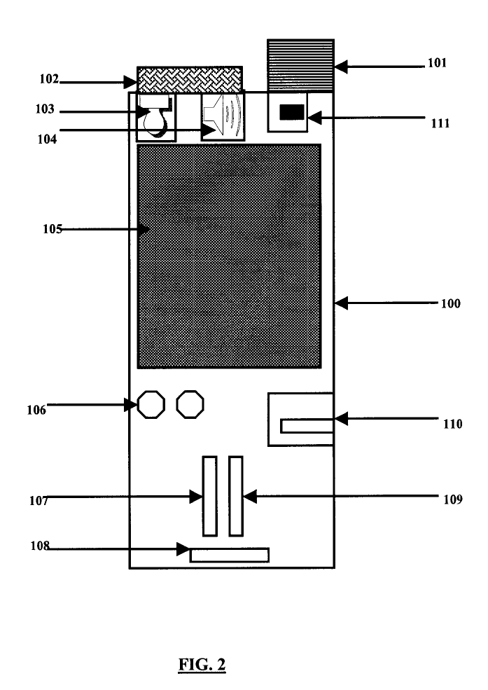

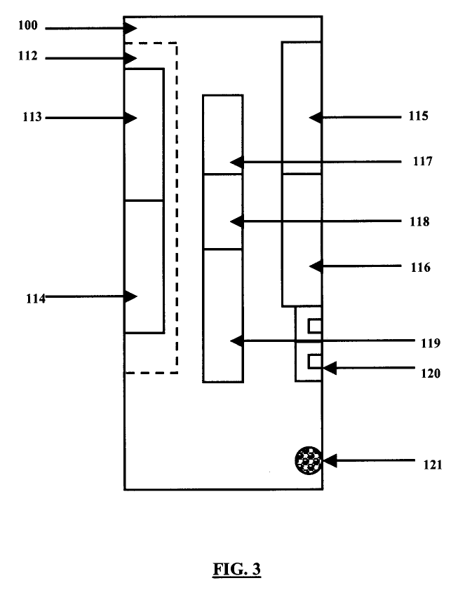

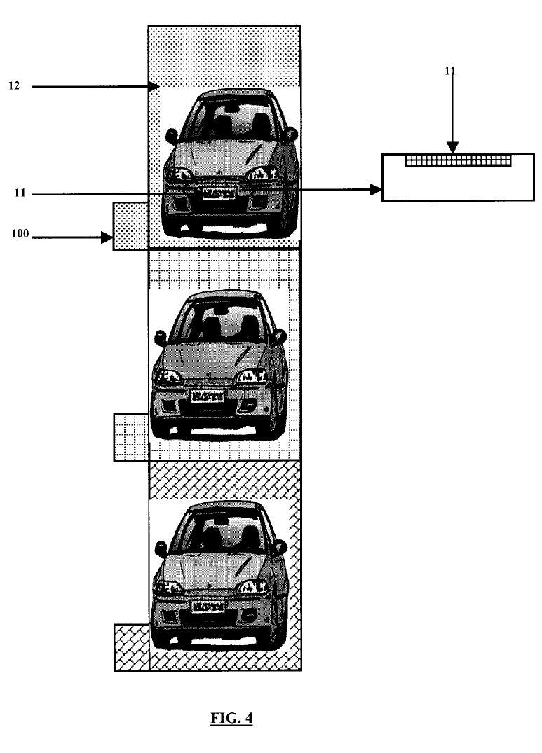

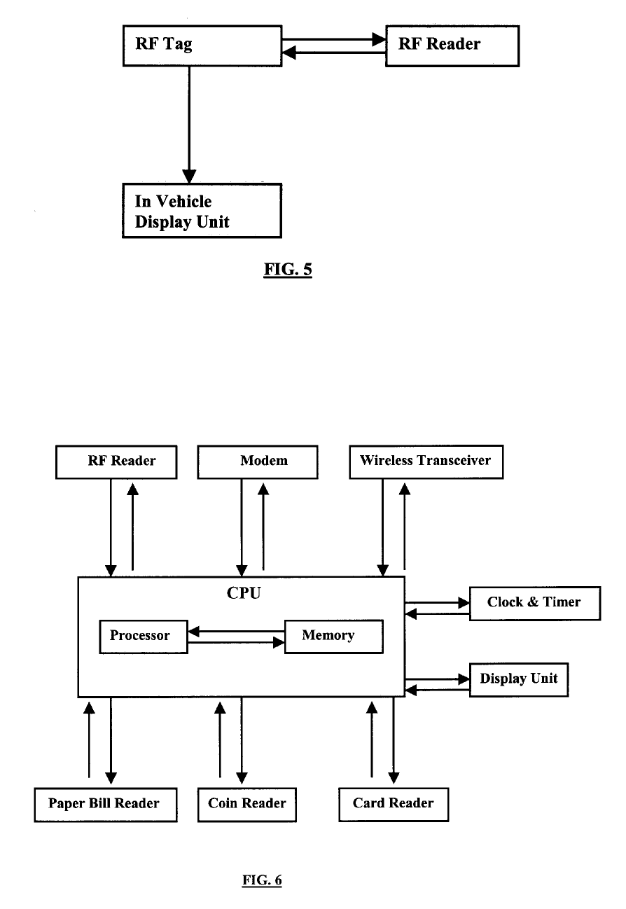

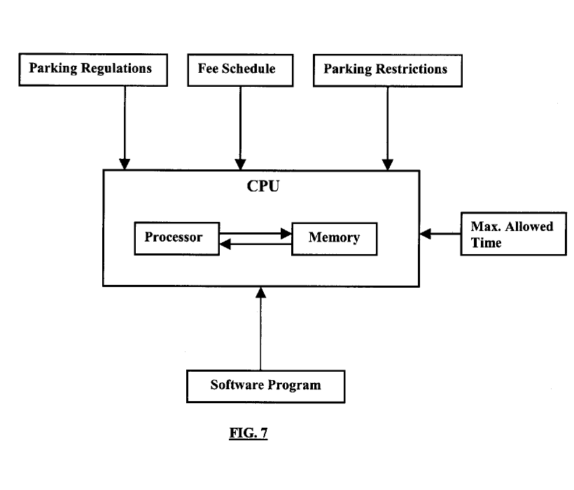

The parking system of the present invention comprises of a smart parking meter (100) mounted on top of a support stand (10) as shown in FIG. 1. FIGS. 2 & 3 show the preferred embodiment of the smart parking meter (100) in details. The smart parking meter (100) contains an interrogator (101), which in the preferred embodiment, is a radiofrequency (RF) reader (101). The RF reader (101) has an interrogation range that covers one corresponding parking stall (12) as shown in FIG. 4. The smart parking meter (100) contains a central processing unit (CPU; 112) comprising of a processor (113) and a memory chip (114). A modem (115), two-way wireless transceiver (116) and communication ports (120) are provided. An internal clock (117) and timer (118) with means to control and trigger time sensitive functions are provided. The smart parking meter (100) has a printer (110) with means to print parking tickets and the like. The smart parking meter (100) is enclosed in a housing, which preferably, is made of a tamper proof, weather and water resistant material. A display unit (105), which in the preferred embodiment is a liquid crystal display (LCD) screen, is provided on the housing. The housing also has a visual alarm (103) and an audio alarm (104). A plurality of control switches (106 &111) is provided that enable local command entry into the smart parking meter (100). Commands can also be entered into the smart parking meter (100) via the display unit (105) using touch screen technology. The meter includes a coin receptor (107) with unique means for coin detection, slug detection, determination of coin denomination, and jam detection. Similarly, the meter also includes a paper bill receptor (108) with unique means for paper bill detection, slug detection, determination of paper bill denomination, and jam detection. The smart parking meter (100) is also intended to be used with an account card incorporating a read/write memory (e.g. a magnetic strip) pre-recorded with a monetary value. The smart parking meter has a slot (109) or the like for receiving the account card, means for reading the memory on the card, a comparator for comparing information from the memory with stored information and an amending device for amending the memory on the account card to deduct the value of the parking period bought by the user. Means for accepting and processing credit and debit cards is also provided. Acceptable forms of payment in the future may include smart cards (also commonly referred to as IC cards). According to another envisioned system, a predetermined available credit is recorded into the RF tag (11) of the vehicle, so as subsequently to be automatically decremented by the smart parking meter (100) in respect of actual use. In such a situation, the smart parking meter (100) serves as card filler; payment made at the smart parking meter (100) is transmitted to the RF tag (11) as credit to be used for future parking. A battery compartment (119) is located in the housing, which holds one or more batteries to power the smart parking meter (100). In the preferred embodiment, the battery is a solar battery, but it may be of any other kind like lithium, nickel etc. A solar panel (102) to charge the solar battery is provided on the housing. An electrical terminal (121) for connection to an external source of power is also provided. As shown in FIG. 6, the CPU has two way communication with other components of the smart parking meter including RF reader, modem, wireless transceiver, clock, timer, display unit, card reader, coin reader and paper bill reader.

Vehicles are provided with radiofrequency identification tags (RF tags. In the preferred embodiment, the RF tag (11) is mounted on the license plate as shown in FIG. 4, but it may be located anywhere in the body of the vehicle. Preferably, it has a tamper proof, weather and water resistant encasing. In addition to transmitting information, the RF tag (11) has means to receive and store information obtained from the RF reader (101) as shown in FIG. 5. The RF tag (11) is connected to the internal circuitry of the vehicle and has means to display information contained therein, on a display unit in the vehicle. Although the tag in the preferred embodiment is a radiofrequency transponder, other transponders like Surface Acoustic Wave (SAW) transponder or a Dense Wave Multiple Access (DWMA) transponder may be used.

Operation:

The RF tag (11) contains vehicle identification information like registration number, license plate number, vehicle identification number (VIN), year, make, model, owners name and contact information and the like. The information contained in the RF tag (11) can be updated whenever necessary, for example when there is change in ownership. Alternately, vehicle identification information, including registration number, license plate number, VIN, make, model and year of the vehicle and the like is stored in a central computer system, which maintains a database containing information pertaining to all vehicles. Individual vehicle identification data is linked to a unique serial number of the RF tag (11) of the corresponding vehicle. The said database is organized such that reference is made to vehicles by their respective RF tag serial numbers; and data linked to a corresponding RF tag serial number can be readily pulled. The RF tag (11) has means to receive information from a RF reader (101) and accordingly update information contained therein as illustrated in FIG. 5. This can be done at the smart parking meter (100) or at other locations with appropriately configured RF readers, like a transportation office. This feature of the present invention has practical applications. For example, currently drivers are required to register their vehicles, renew their vehicle registration and the like; by mail or in person at a motor vehicle facility. Instead, with RF tags (11), these tasks can be done at any parking stall equipped with a smart parking meter (100). In the illustrated example of annual vehicle registration renewal, the RF reader (101) interrogates the RF tag (11) of a vehicle and transmits the information obtained from the RF tag (11) to a central control station, where the computer system determines if renewal is due. If the registration of the said vehicle is due for renewal, a notice to that effect is displayed on the display unit (105) of the smart parking meter (100). The driver of the said vehicle has the option pay the renewal fee using payment options at the smart parking meter. Once appropriate fee is paid, the RF reader (101) of the smart parking meter is instructed by the central control station to update the RF tag (11) of the vehicle. It is to be appreciated that that the smart parking meter (100) enables a municipality to save large expenses that is incurs to maintain facilities and staff to process tasks like vehicle registration and registration renewal.

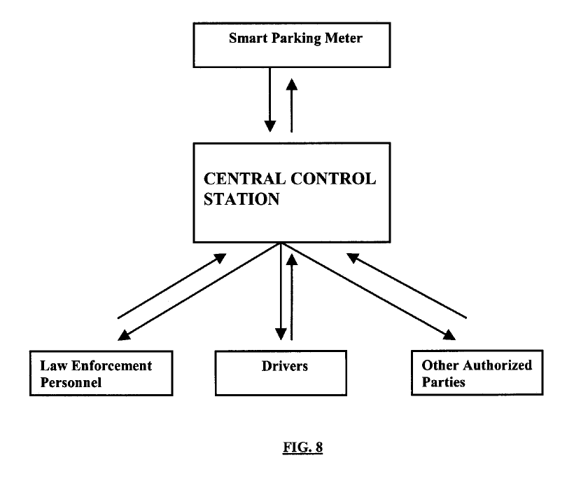

FIG. 7 shows the basic programming of the smart parking meter. The CPU (112) of the smart parking meter is operated by a software program. Information regarding parking regulations, enforcement times, parking fee structure, parking restrictions, maximum allowable time and any other relevant information is entered into the CPU (112). All or some of this information is displayed on the display unit (105) for the benefit of drivers. The smart parking meter (100) provides a dynamic platform to implement changes to parking fee structure, parking restrictions, parking regulations, maximum allowed time and the like. These changes can be made remotely from a central control station, from a portable device carried by parking officials, or manually at the smart parking meter (100). For example, conventional parking meters usually have a fixed parking fee schedule, changes to which are cumbersome and expensive to make. With smart parking meters it is possible to change parking fee schedule from time to time, such as during special events like a baseball game. This could generate additional revenue for the municipality. It is a common practice to enforce special parking restrictions during certain times. Another example; parking restrictions is enforced in winter season during months when snow is expected. With the current parking system, these restrictions are enforced even on days when there is no precipitation of snow. This leads to loss of revenue that would otherwise be collected if parking restrictions were imposed only on days when there is precipitation of snow. The smart parking meter (100) enables restrictions to be imposed in real time, in a dynamic fashion. Hence, restrictions may be imposed only on days when there is a need to do so. Means are provided in the parking enforcement system of the present invention to enforce parking regulations that are displayed on the smart parking meter.

The smart parking meter (100) communicates with a central control station by means of the wireless transceiver (116), as in the preferred embodiment, or through wired connection by means of modem (115). As shown in FIG. 8, the smart parking meter (100) communicates with a central control station which, in turn communicates with law enforcement agencies, drivers and other authorized parties to form a communication network. Communication means may include one or more of: a) internet; b) world wide web; c) intranet; d) extranet; e) virtual private network; d) cellular network; e) telephone network; f) fiber optic network; g) cable network; h) satellite network; i) GPS link or any other means of communication. Each smart parking meter (100) has a unique identification code. All information pertaining to a smart parking meter (100), including geographic location, is linked to its unique identification code and is stored in the computer system at the central control station, which maintains a database containing information pertaining to all smart parking meters in a given area, including the exact location of each smart parking meter (100). The database is organized such that reference is made to smart parking meters by their ID's; and data linked to the corresponding smart parking meter ID can be readily pulled.

Information regarding parking regulation, rental fee, parking restrictions and the like, is displayed on the display unit (105) for the benefit of drivers. It is to be appreciated that display of information at the parking meter is a more convenient and practical way to disseminate information. Currently, parking signs are posted along a street. These signs may not be visible to all drivers, especially when they park far from the location of the signs. This is especially problematic in case of elderly drivers with compromised vision or when visibility is poor because of weather conditions.

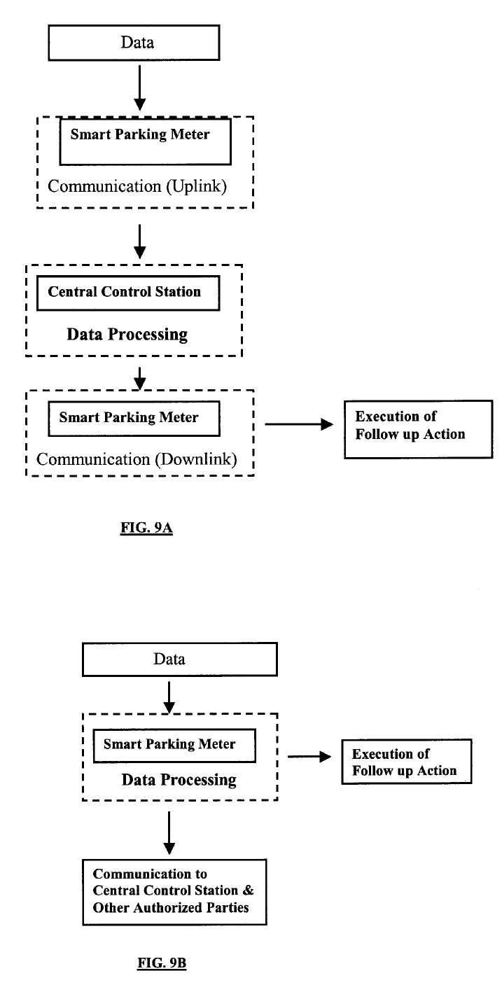

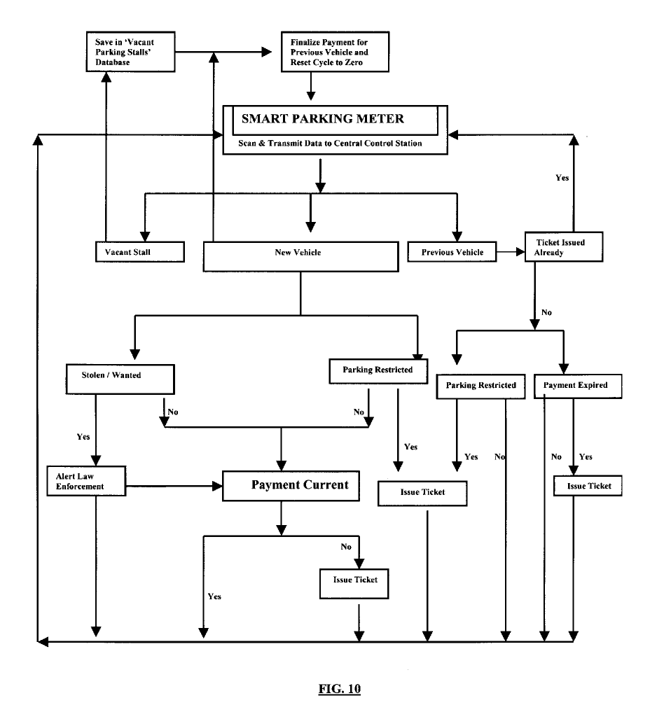

Processing of gathered data is central to the functioning of the smart parking meter (100). Data processing can be done in two ways as shown in FIGS. 9A & 9B. According to the first method shown in FIG. 9A, the smart parking meter gathers data and transmits it to a central control station (uplink). The data is processed by the computer system at the central control station, where determination is made regarding follow up action. The central control station then transmits instructions regarding follow up action to the smart parking meter (downlink), which executes the said follow up action. According to another method illustrated in FIG. 9B, data processing is done at the smart parking meter level and then communicated to desired parties, including the central control station. The smart parking meter executes follow up actions according to programmed instructions. One or both these methods of data processing can be used interchangeably and should not be regarded as limiting.

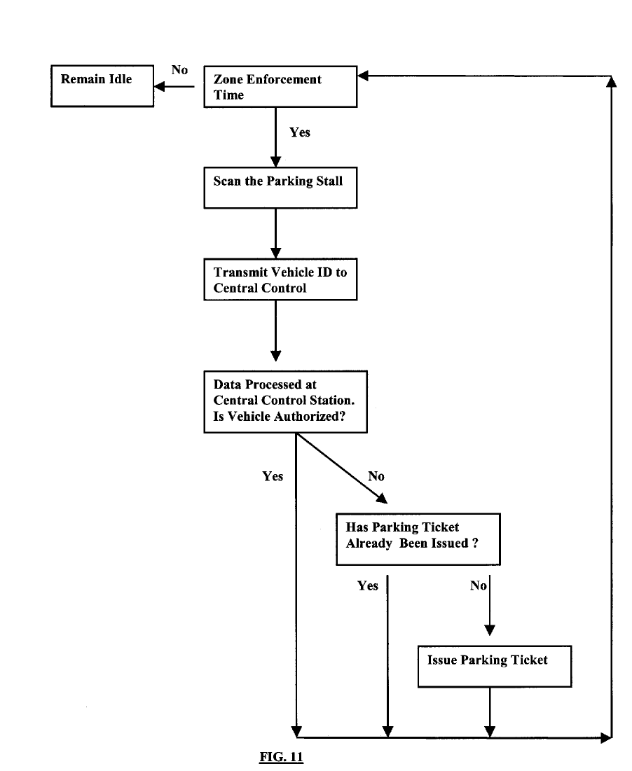

An algorithm to enable the smart parking meter to enforce parking regulations is shown in FIG. 10. When a driver pulls into a vacant parking stall, a pre determined grace period is given to deposit payment. The grace period is long enough for the driver to comfortably park his vehicle. Payment can be made using coins, paper bills, pre paid cards, credit and debit cards. The parking fee schedule and enforcement times are displayed on the display unit. The RF reader (101) scans the corresponding parking stall at regular intervals and interrogates the RF tag (11) of the vehicle. Alternatively, the driver can initiate a scan using a control switch (111). The information obtained from the RF tag (11) of the vehicle is transmitted to central control station. In the preferred embodiment, data is processed at the central control station. The computer system at the central control station contains all parking enforcement instructions including parking regulations, fee schedule, parking restrictions, maximum allowed time and any other pertinent information. It is programmed to correlate the vehicle data obtained from the smart parking meters with the parking enforcement instructions to determine whether or not the said vehicle is legally parked. The payment status of the parked vehicle is checked after the lapse of the grace period. If no payment is posted within the grace period, it is determined to be delinquent and the smart parking meter (100) is instructed to issue a parking ticket. The information contained in the parking ticket includes nature of violation, penalty, payment due date, accepted forms of payment and any other relevant information; similar to information contained in a conventional parking ticket. In the preferred embodiment, the parking ticket is printed at the smart parking meter using the printer (110). The smart parking meter gives a visual and/or audio alert (103, 104) when a parking ticket is issued in order to notify the driver. At the same time, the RF reader (101) transmits parking ticket information to the RF tag (11) present on the said vehicle. Information contained in the RF tag (11) is displayed on a display unit present in the vehicle at regular intervals, reminding the driver of the parking ticket. When the ticket is paid, information on the RF tag (11) of the vehicle is updated accordingly. This system has many advantages 1) the parking ticket information is displayed till it is paid or dismissed, which will increase compliance; 2) by this means, it is impossible for the parking official to report a fictitious parking violation to the municipality since every such claim must be supported by the parking ticket information stored within the RF tag (11). Clearly, this cannot be entered fraudulently by the parking official; 3) furthermore, the driver also is unable subsequently to deny ever having received a parking ticket since the issue of such a ticket is indelibly recorded in the memory of the RF tag (11); 4) instantly identifies ‘scofflaw’ drivers; when the smart parking meter (100) identifies a vehicle that has not paid previous parking tickets, it alerts the central control station. It also activates the visual and/or audio alarm (103, 104) to alert a nearby parking official. The smart parking meter (100) may also be programmed to alert a parking official on a portable communication device. In addition to smart parking meters, ‘scofflaw’ drivers can also be identified using a portable device containing an interrogator; such as those carried by parking personnel on manual patrol.

If the parking status is deemed to be current, the smart parking meter (100) takes no action. As illustrated in FIGS. 9A & 9B; the determination of whether or not a vehicle is parked legally, can be made at the level of the central control station as in the preferred embodiment, or at the smart parking meter (100) level. The RF reader (101) scans the parking stall at regular intervals or it may be programmed to scan continuously. The central computer system assess for payment status every time the parking stall is scanned and matches the current information obtained from the RF tag (11) of the parked vehicle to the information obtained at the time of last payment. If the current vehicle information does not match the vehicle information that was obtained at the time of last payment, or if the parking stall is sensed to be vacant, the smart parking meter (100) is reset to zero and payment is required of a vehicle parked thereafter. With conventional parking meters, sometimes a driver does not need to pay, as fee paid by the previous driver is still active. The smart parking meter (100) does not permit this practice. A new driver is required to pay parking fee, regardless of what the previous driver had paid. This increases revenue for the municipality. This also prevents drivers from paying for parking time they don't use as the smart parking meter (100) finalizes payment once a vehicle leaves and charges only for the time during which the vehicle was parked. This is in contrast to the present system wherein, once a payment is made, parking for a fixed time is bought, regardless of when the vehicle is removed.

It is to be appreciated that the smart parking meter (100) allows drivers to pay parking rental, parking tickets and any other vehicle related payments using credit/debit cards, pre paid cards, paper bills and coins of various denominations or various combinations thereof. This will increase compliance among drivers and increase revenue for the municipality. According to another envisioned system, a predetermined credit is recorded into the RF tag (11) of the vehicle so as subsequently to be automatically decremented by the smart parking meter (100) in respect of actual use. In such a situation, the smart parking meter (100) serves as card filler; payment made at the smart parking meter (100) is transmitted to the RF tag (11) as credit to be used for future parking. If a driver wishes to contest a parking ticket, the smart parking meter (100) enables him to notify the central control station of his intent using a control switch (106). The central control station remotely notifies a driver regarding court date and other procedural information, which is displayed on display unit (105) and printed at the smart parking meter (100) using the printer (110). This information is also transmitted to the RF tag (11) of the vehicle and then displayed on an onboard display unit for the benefit of the driver. It is to be appreciated that the smart parking meter (100) saves the municipality large expenses it incurs to employ staff and put other logistics in place to process parking tickets.

The smart parking meter (100) can be very useful in areas with zone parking restrictions as shown in FIG. 11. With conventional parking meters, determining whether a vehicle is legally parked in a zone area during restricted times requires manual inspection by a parking official. This is especially problematic when the restricted times are outside of normal working hours, such as overnight, which typically is the case in metropolitan cities. Information regarding restricted times is entered in the CPU (112) of smart parking meters located in a said zone area. The smart parking meters are programmed to scan corresponding parking stalls during restricted times. In the preferred embodiment, the smart parking meter (100) transmits ID of a parked vehicle to a central control station. The computer system at the central control station determines if the said vehicle is legally parked. If violation is detected, the central control station instructs the smart parking meter (100) to issue a parking ticket. According to another method, the RF tag (11) on authorized vehicles contains an authorization code for the said zone area. The smart parking meter (100) recognizes the authorization code and after interrogating the RF tag (11) of a vehicle, is able to determine whether or not a vehicle is authorized to park in the said zone area. A parking ticket is issued if an unauthorized vehicle is detected. Another method is envisioned, wherein each smart parking meter (100) contains a list of all authorized vehicles for the said zone area. It matches the vehicle ID obtained from the RF tag (11) of a vehicle with the database contained therein. If the parked vehicle is not found in the database of authorized vehicles, a parking ticket is issued. The database of the smart parking meters in the said zone area is updated regularly.

The smart parking meter (100) can be very helpful in locating vehicles wanted by law enforcement agencies, such as stolen vehicles, vehicles involved in unlawful activities and the like. A central control station has access to data from all smart parking meters within its network. The network of the central control station can be city wide, county wide, state wide, countrywide or can cover any desired geographic area. The central control station has a master database that contains all information obtained from all smart parking meters, both real time and past. ID of the vehicle wanted by a law enforcement agency is entered into the computer system at the central control station; which then matches it with the master database contained therein. The central computer system has means to determine whether the wanted vehicle is presently parked in a parking stall within its network, and if so, it can determine its exact location. If the vehicle is presently not parked within the network, the computer system at the central controls station has means to determine if the said vehicle was parked in a parking stall within its network in the past. This is helpful to the law enforcement agencies in determining the general location of the said vehicle during a specified time period. According to another method, all smart parking meters within the network of the central control station are fed with the ID of the wanted vehicle. When a smart parking meter (100) identifies the wanted vehicle in its parking stall, it alerts the central control station. The central control station determines the exact location of the said smart parking meter (100) and alerts law enforcement personnel. Alternatively, the smart parking meters can be programmed to alert law enforcement personnel directly. It can also be programmed to give a visual and/or audio alarm when it detects a wanted vehicle to notify a near by law enforcement personnel.

The vehicle locator feature of the present invention can also be useful for drivers who forget where they had parked their vehicle. This is especially useful for elderly and drivers with cognitive impairment. Drivers can provide their vehicle ID by phone, internet or any other communication means to the central control station. The computer system at the central control station searches its real time database to locate the vehicle in question; and informs the driver of its exact location. The vehicle locator service can provide an additional source of revenue for the municipality.

The smart parking meter (100), in addition to being used in ‘on street’ parking stalls, can also be used in ‘off street’ parking lots. Currently parking attendants are required to be present onsite to monitor parking and collect parking rentals at ‘off street’ parking lots. According to another aspect of the present invention, each parking stall in an ‘off street’ parking lot is equipped with a smart parking meter (100). Information regarding parking regulations, parking fee schedule, enforcement times, parking restrictions and maximum allowed time is fed into the smart parking meter (100) and displayed on the display unit (105). Drivers can pay parking rental fee using coins, paper bills, prepaid cards and credit/debit cards. Receipt for payment is printed at the printer (110). The smart parking meter (100) scans the corresponding parking stall at regular intervals and transmits the ID of a parked vehicle to a central control station. In the preferred embodiment, determination of whether or not a vehicle is legally parked is made at the central control station based on parking enforcement information entered in the central computer system therein. The central control station instructs the smart parking meter (100) to issue a parking ticket when it detects a parking violation. Alternatively, the smart parking meter (100) can be programmed to analyze the gathered data, make determination regarding parking violation and take appropriate follow up action. The central control station communicates with smart parking meters in one or more parking lots. It is to be appreciated that the smart parking meter (100) enables remote management and obviates the need for a parking attendant to be present onsite, thereby reducing the operating costs and maximizing profits for the municipality.

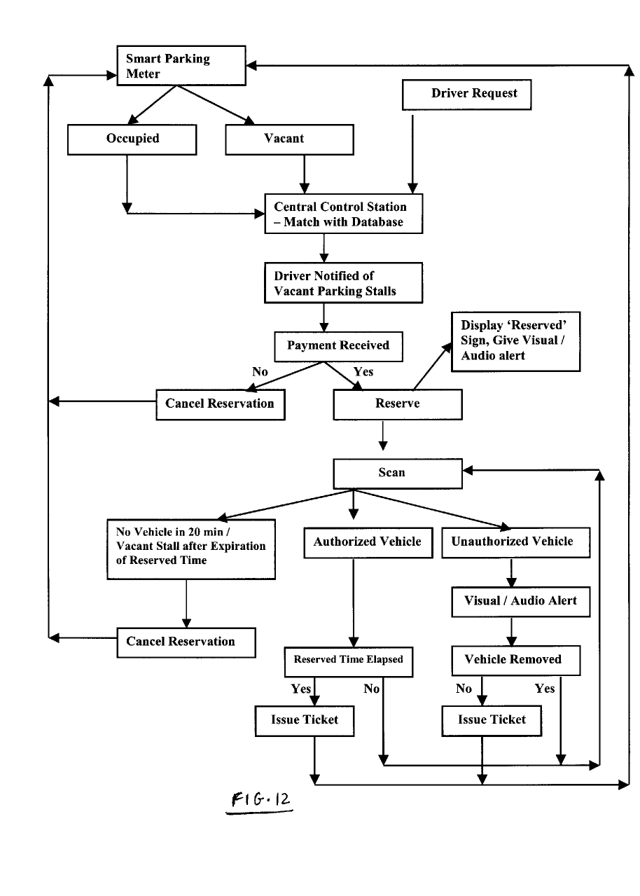

Drivers sometimes have to drive for long periods of time to find a vacant parking stall. This is especially true in commercial and downtown areas. With the present parking system, finding a vacant parking stall is a play of luck. A driver may find a vacant parking stall earlier than another driver who may have been looking for longer. A parking system using smart parking meters has means to locate vacant parking stalls and means to enable drivers to reserve a vacant parking stall on a first come first serve basis. The vacant parking stall locator and reservation system is shown in FIG. 12. A smart parking meter (100) scans its corresponding parking stall using RF reader (101) and alerts the central control station if the said parking stall is vacant. A parking stall is determined to be vacant when the RF reader (101) is unable to locate a RF tag (11) within the said parking stall. Although RFID technology is used in the preferred embodiment, other technologies like SONAR, optical detection and the like can be used to determine if a parking stall is vacant. The computer system at the central control station maintains a database of all vacant parking stalls and determines their geographic location by matching the ID's of parking meters on vacant stalls with the linked database that contains the location of smart parking meters. A driver looking for a vacant parking stall contacts the central control station by phone, internet or any other communication means and provides his location, the desired location a vacant parking stall and his vehicle ID. Alternatively, the location of the vehicle can be obtained from a global positioning system (GPS) device. The central control station advises the driver of the nearest vacant parking stall by matching the location of the said vehicle with the database of vacant parking stalls. In addition, the driver can reserve a vacant parking stall by making required payment in advance. The central control station remotely sends the vehicle ID and reservation information to the reserved smart parking meter, which then displays a ‘reserved’ message and the authorized vehicle's ID on its display unit (105) and gives and audio and/or visual alarm (103, 104) to that effect. When a vehicle pulls up in the reserved parking stall, the smart parking meter (100) interrogates the RF tag (11) on the vehicle. It transmits the obtained information to the central control station where determination regarding the authorization status of the said vehicle is made. Alternatively, the smart parking meter (100) can be programmed to determine the authorization status of a parked vehicle. If it is an authorized vehicle, a visual and/or audio signal is given to that effect to notify the driver that he is in the right parking stall. If a vehicle other than the authorized vehicle is detected during the time when the smart parking meter (100) displays the ‘reserved’ message, a visual/audio signal is given to notify the driver of the same. If the unauthorized vehicle is not removed after a certain time period, a parking ticket is issued. If the authorized vehicle is not parked in the parking stall within a certain pre determined time period, the reservation is cancelled and the parking stall is made available to other drivers. In case no vacant parking stall is available at the time when a driver contacts the central control station, he is put on a waiting list and is informed by phone, pager, on board computer, internet or any other communication means when a parking stall becomes available. The vacant parking stall locator and reservation system can be an additional source of revenue for the municipality.

The smart parking meter (100) is programmed to perform self check at regular intervals and report its functional status to the central control station. The meter diagnostic feature alerts repair personnel to specific malfunctioning meters in the same manner that the parking authorities are notified of parking violations. Meter diagnostics are performed during early morning hours, before general business commences, and at regular intervals throughout the general business day. This feature includes, among other things; 1) full coin and/or paper bill compartment; 2) low battery indication; 3) meter CPU failure; 4) communications failure; 5) meter tamper; 6) RF reader failure. Also a transducer (mercury type switch) is located in the parking meter (not shown) to detect if someone is tampering with the smart parking meter. If tampering is detected, a signal is sent to the central control station and an attendant or a police officer is dispatched to the location. The self diagnostic feature of the smart parking meter will be helpful in challenging contests from drivers who claim malfunction of the parking meter as the reason for their non payment.

What is claimed is:

1. A transponder containing vehicle identification information located in a vehicle.

2. The transponder of claim 1, wherein it is a Radiofrequency Transponder.

3. A parking meter comprising of an interrogator, which has means to interrogate a transponder located in a vehicle.

4. The parking meter of claim 3 wherein the interrogator is a Radiofrequency Reader.

5. The parking meter of claim 3 wherein the interrogator has means to transmit information to a transponder.

6. The transponder of claim 1, wherein it has means to store information received from an interrogator.

7. The parking meter of claim 3 further comprising of 1) processor; 2) memory chip; 3) payment acceptance means; 4) communication means; 5) display unit.

8. A parking enforcement system comprising of; 1) A transponder located in a vehicle that contains vehicle identification information; 2) A parking meter, comprising of an interrogator, with means to interrogate the above transponder.

9. The parking enforcement system of claim 8 wherein the parking meter has means to communicate with a remote center.

10. The parking enforcement system of claim 8 wherein the remote center has means to determine whether or not a vehicle is legally parked.

11. The parking enforcement system of claim 8 wherein the parking meter has means to issue parking tickets.

12. The parking enforcement system of claim 8 wherein the parking meter has means to determine whether or not a vehicle is legally parked.

13. A system of reserving parking stalls comprising the steps of; 1) Receiving a driver request for a vacant parking stall; 2) A central site collecting parking availability information transmitted from sensor devices monitoring associated parking spaces; 3) Generating navigational information as a function of said vacant parking stalls; 4) Driver receiving a response message representative of vacant parking stalls in a geographic area; 5) Central site transmitting reservation information to the parking meter corresponding to a reserved parking stall; 6) The said parking meter displaying reservation information.

14. The system of reserving parking stalls of claim 13 wherein it has means to determine the identity of a vehicle.

15. A system of locating a wanted vehicle comprising the steps of; 1) A transponder, containing vehicle identification information, located in vehicles; 2) Parking meters, comprising of an interrogator device, with means to interrogate the above transponder; 3) A multitude of parking meters communicating with a central site to form a network; 4) The said central site collecting vehicle identity information transmitted from interrogator device present on parking meters in its network; 5) The said central site determining if the said vehicle is present in a parking stall in its network.

16. The system of locating a wanted vehicle of claim 15 wherein the central site has means to determine if the said vehicle was parked in a parking stall in the past.

17. A vehicle management system comprising of 1) A transponder, containing vehicle identification information, located in a vehicle; 2) An interrogator device, with means to interrogate the said transponder; 3) The said transponder with means to store information received from an interrogator device.

18. A method of driver education comprising of the vehicle management system of claim 16 wherein the transponder has means to display information stored therein; on a display unit present in the vehicle.

19. A method of identifying drivers who have not paid previous parking tickets comprising of the vehicle management system of claim 16 wherein 1) parking ticket information is stored in the said transponder; 2) parking ticket information stored in the said transponder is made available upon interrogation by an interrogator device.

20. A method of vehicle registration comprising of the parking management system of claim 16 wherein 1) the said interrogator device transmits vehicle registration information to the transponder located in a vehicle; 2) vehicle registration information is stored in the said transponder.

21. A method of driver education comprising of 1) a parking meter with a display unit 2) a parking meter with means to communicate with a remote station 3) a parking meter with means to display information received from remote station.

22. A parking enforcement system comprising of the parking meter of claim 21 wherein means are provided to enforce parking regulations displayed on the parking meter.
